(19) United States
(12) Patent Application Publication
(10) Pub. No.: US 2024/0403038 A1
(43) Pub. Date: Dec. 5, 2024

(54) SOFTWARE BUILD SYSTEM, SOFTWARE DEVELOPMENT ASSISTANCE METHOD AND NON-TRANSITORY COMPUTER READABLE RECORDING MEDIUM ENCODED WITH SOFTWARE DEVELOPMENT ASSISTANCE PROGRAM

(71) Applicant: KONICA MINOLTA, INC., Tokyo (JP)

(72) Inventor: Shin OHBA, Toyokawa-shi (JP)

(73) Assignee: KONICA MINOLTA, INC., Tokyo (JP)

(21) Appl. No.: 18/675,726

(22) Filed: May 28, 2024

(30) Foreign Application Priority Data
May 29, 2023 (JP) 2023-088258

(51) Int. Cl. G06F 8/71

(52) U.S. Cl. CPC G06F 8/71

(57) ABSTRACT

A software build system includes a hardware-processor, wherein the hardware processor acquires a due date defined for software, associates a virtual server provided by a service that supplies the virtual server with the software, and determines performance of the virtual server based on information about the software.

### CROSS-REFERENCE TO RELATED APPLICATIONS

The entire disclosure of Japanese patent Application No. 2023-088258 filed on May 29, 2023 is incorporated herein by reference in its entirety.

### BACKGROUND OF THE INVENTION

### Technical Field

The present invention relates to a software build system, a software development assistance method, and a computer-readable recording medium encoded with a software development assistance program. In particular, the preset invention relates to a software build system that builds software by using a virtual server, a software development assistance method of assisting a software build by using a virtual server, and a computer-readable recording medium encoded with a software development assistance program that causes a computer to execute the software development assistance method.

### Description of Related Art

In case of software development, a source file of software or an editing history is stored in a repository for management of its versions, and the software is developed efficiently. A technique for utilizing this information stored in the repository and adjusting the order of a build of a plurality of pieces of software is known. For example, Japanese Unexamined Patent Publication No. 2017-215762 describes a software build system that makes a software build request to a compilation server group based on a source code committed by a designer, a build priority registered in a development theme management system, and a countermeasure priority registered in a failure management system.

However, in the software build system described in Japanese Unexamined Patent Publication No. 2017-215762, software having a high priority is built in preference to software having a low priority. Therefore, there is a problem that a software build with a low priority is delayed. Therefore, it is desired to enhance the performance of a build server to shorten a period of time spent on a software build.

In order to shorten a period of time spent on a software build, it is necessary to use a build server with high performance. However, the cost of such a build server is high. In recent years, a service for producing a virtual server on a cloud has been known. With utilization of this service, a virtual server can be produced for each software build. However, there is a problem that, it is necessary to set a build environment in a virtual server in order to use the virtual server as a build server, and the work is complicated. As a service for counteracting this problem, there is a service that provides another virtual server obtained by duplication of a virtual server in which a build environment is set. By using this service, it is not necessary to set a build environment.

On the other hand, the cost for receiving a service varies depending on a performance difference of a virtual server. The higher the performance of a virtual server, the higher a fee. Depending on the performance of a virtual server in which a build environment is previously set, the fee of a virtual server obtained by duplication of the virtual server is determined. However, because the performance required for a virtual server varies depending on various factors such as a software development stage and a due date, it is difficult to define the performance of the virtual server to be produced first. The performance of a virtual server is degraded in a case in which the cost is cut down. Therefore, there is a problem, that a period of time spent on a build is increased, and software cannot be efficiently developed. Conversely, when the performance of a virtual server is enhanced, there is a problem that, the cost is increased although software can be efficiently developed.

### SUMMARY OF THE INVENTION

According to one aspect of the present invention, a software build system includes a hardware-processor, and the hardware processor acquires a due date defined for software, associates a virtual server provided by a service that supplies the virtual server with the software, and determines performance of the virtual server based on information about the software.

According to another aspect of the present invention, a software development assistance method includes a due-date acquiring step of acquiring a due date defined for software, an associating step of associating a virtual server provided by a service that supplies the virtual server with the software, and a performance determining step of determining performance of the virtual server based on information about the software.

According to yet another aspect of the present invention, a non-transitory computer readable recording medium is encoded with a software development assistance program that causes a computer to execute a due-date acquiring step of acquiring a due date defined for software, an associating step of associating a virtual server provided by a service that supplies the virtual server with the software, and a performance determining step of determining performance of the virtual server based on information about the software.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating one example of the overview of a software build system in the present embodiment;

FIG. 2 is a block diagram illustrating one example of the hardware configuration of a build environment management server;

FIG. 3 is a first sequence diagram illustrating the sequence of a software build in the software build system;

FIG. 4 is a second sequence diagram illustrating the sequence of the software build in the software build system;

FIG. 5 is a block diagram illustrating one example of the functions of a CPU included in a build environment management server;

FIG. 6 is a diagram illustrating one example of an administrator build instruction screen;

FIG. 7 is a diagram illustrating one example of a reproduction instruction screen;

FIG. 8 is a diagram illustrating one example of a developer build instruction screen;

FIG. 9 is a diagram illustrating one example of a version management table;

FIG. 10 is a diagram illustrating one example of a build history table;

FIG. 11 is a diagram illustrating one example of a performance level table;

FIG. 12 is a graph illustrating one example of the relationship between a performance level and a due date;

FIG. 13 is a flowchart illustrating one example of a flow of a virtual server production process;

FIG. 14 is a flowchart illustrating one example of a flow of a virtual server reproduction process;

FIG. 15 is a flowchart illustrating one example of a flow of a performance determination process; and

FIG. 16 is a flowchart illustrating one example of a flow of an increase rate determination process.

### DETAILED DESCRIPTION

Hereinafter, one or more embodiments of the present invention will be described with reference to the drawings. However, the scope of the invention is not limited to the disclosed embodiments.

A software build system according to embodiments of the present invention will be described below with reference to the drawings. In the following description, the same components are denoted by the same reference numerals. Their names and functions are the same. Therefore, the detailed description thereof will not be repeated.

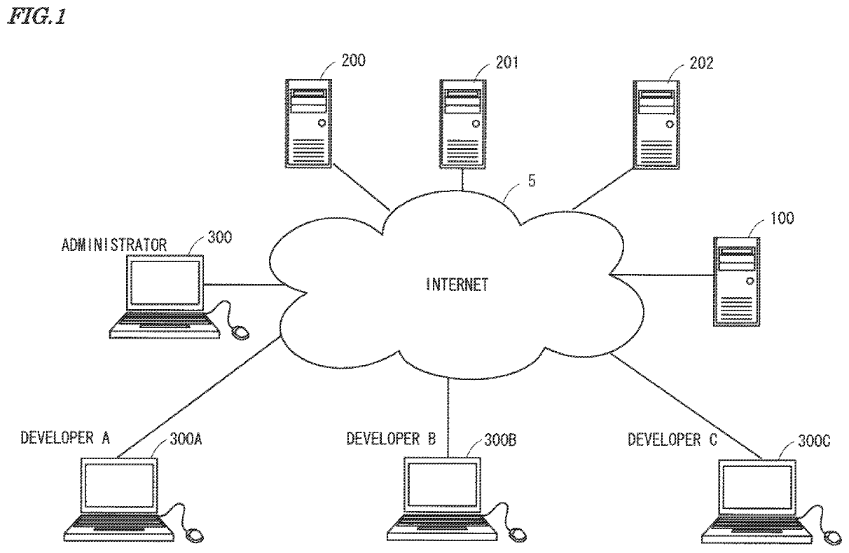

FIG. 1 is a diagram illustrating one example of the overview of a software build system in the present embodiment. The software build system 1 includes a build environment management server 100, a service provision server 200, a version management server 201, a due-date management server 202, an administrator PC 300 and developer PCs 300A to 300C.

The build environment management server 100, the service provision server 200, the version management server 201, the due-date management server 202, the administrator PC 300 and the developer PCs 300A to 300C are connected to a network 5 and can communicate with one another. The network 5 is the Internet. The network 5 is not limited to the Internet, and may be a Wide Area Network (WAN), a Public Switched Telephone Network (PSTN), a local area network or the like. The build environment management server 100, the service provision server 200, the version management server 201, the due-date management server 202, the administrator PC 300 and the developer PCs 300A to 300C may be connected to the network 5, wired or wireless.

The build environment management server 100, the version management server 201 and the due-date management server 202 are general computers, and the configurations thereof are well known. Therefore, the description thereof will not be repeated here.

The service provision server 200 is a computer managed by a business operator that provides a service for supplying a virtual server. A user can utilize a service provided by the service provision server 200 by registering as a business operator.

The version management server 201 implements a version management system by executing a version management program for managing a version of software. The version management server 201 has a function of managing a change history of source code. The version management server 201 includes a repository and stores, for each version of software, a source code, an object program, a change history and a related document.

The due-date management server 202 manages a due date of software. The due-date management server 202 defines a due date for each software. A due date of software is the date determined by a software sales person and a client, and is registered in the due-date management server 202 by the sales person in association with the software. In regard to this due date, a first-type due date and a second-type due date are defined. A first-type due date is a due date that cannot be extended. A second-type due date is a due date that can be extended. A first-type due date and a second-type due date are determined by the sales person and the client, for example, and are registered in the due-date management server 202 by the sales person in association with the software. One or both of a first-type due date and a second-type due date are set in regard to one piece of software.

The administrator PC 300 and the developer PCs 300A to 300C are respectively general personal computers. Although the number of the developer PCs is three (the developer PCs 300A to 300C) here, by way of example, the number of PCs is not limited. The number of the developer PCs is simply required to be equal to or larger than one.

In the present embodiment, an administrator and three developers A to C belong to a software development team, by way of example. The administrator operates the administrator PC 300, and the developers A to C respectively operate the developer PCs 300A to 300C, by way of example.

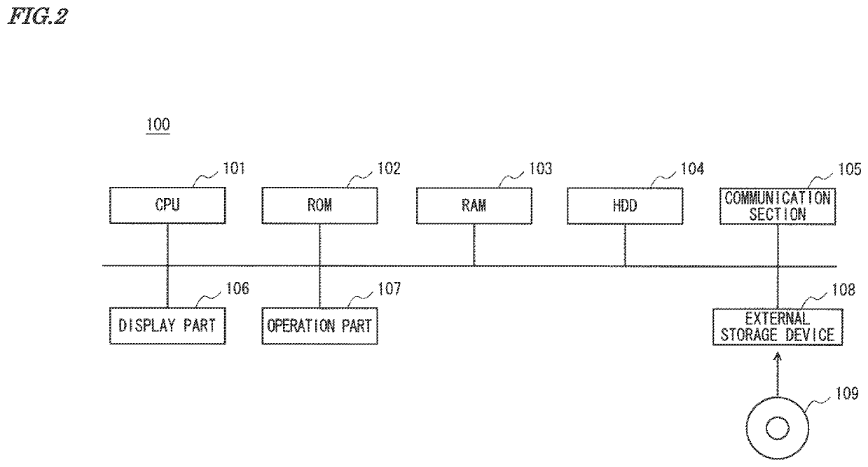

FIG. 2 is a block diagram illustrating one example of the hardware configuration of the build environment management server. With reference to FIG. 2, the build environment management server 100 is a computer that executes arithmetic processing, and includes a Central Processing Unit (CPU) 101 for controlling the build environment management server 100 as a whole, a Read Only Memory (ROM) 102 that stores a program to be executed by the CPU 101, a Random Access Memory (RAM) 103 that is used as a work area for the CPU 101, an HDD 104 that stores data in a nonvolatile manner, a communication section 105 that connects the CPU 101 to a network, a display part 106 that displays information, an operation part 107 that accepts an input of a user operation, and an external storage device 108.

The communication section 105 is an interface for connecting the build environment management server 100 to the network 5. Therefore, the CPU 101 can communicate with the service provision server 200, the version management server 201, the due-date management server 202, the administrator PC 300 and the developer PCs 300A to 300C, that are connected to the network 5, via the communication section 105.

The CPU 101 downloads a program from a computer connected to the network 5 and stores the program in the HDD 104. Further, in a case in which a computer connected to the network 5 writes a program into the HDD 104, the program is stored in the HDD 104. The CPU 101 loads the program stored in the HDD 104 into the RAM 203 and executes the program. Note that, instead of the HDD 104, a semiconductor memory such as an Erasable Programmable ROM (EPROM) that can store data in a non-volatile manner may be used.

A Compact Disk Read Only Memory (CD-ROM) 109 is attached to the external storage device 108. In the present embodiment, the CPU 101 executes a program stored in the ROM 102 or the HDD 104, by way of example. The CPU 101 may control the external storage device 108 to read the program to be executed by the CPU 101 from the CD-ROM 109 and store the read program in the RAM 103 for execution.

A recording medium for storing a program to be executed by the CPU 101 is not limited to the CD-ROM 109 but may be a flexible disc, a cassette tape, an optical disc (Magnetic Optical Disc (MO)/Mini Disc (MD)/Digital Versatile Disc (DVD)), an IC card, an optical card, or a semiconductor memory such as a mask ROM or an Erasable Programmable ROM (EPROM). The program referred to here includes not only a program directly executable by the CPU 101 but also a source program, a compressed program, an encrypted program and the like.

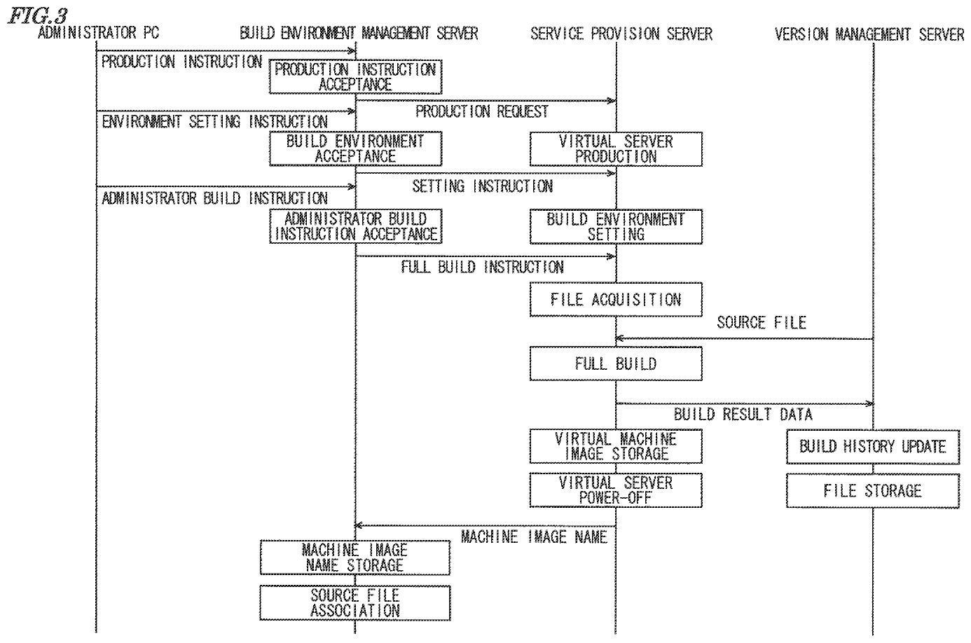

FIG. 3 is a first sequence diagram illustrating the sequence of a software build in the software build system. In FIG. 3, the processes respectively executed and information pieces respectively transmitted and received, by the administrator PC 300, the build environment management server 100, the service provision server 200 and the version management server 201 are illustrated. In FIG. 3, an elapse of time is illustrated in the direction from the top to the bottom. Further, a source program produced by any of the developer PCs 300A to 300C is stored in a repository of the version management server 201, by way of example.

With reference to FIG. 3, the administrator operates the administrator PC 300 to instruct the build environment management server 100 to produce a virtual server. The production instruction includes performance information defining the performance of the virtual server. Although not limited, the performance information includes at least CPU performance, memory performance, storage performance and network performance. The CPU performance includes the number of cores and/or a processing rate of a CPU. The memory performance includes a size and a transfer rate of a main memory. The storage performance includes a size of a non-volatile memory and a type of hardware. The network performance indicates a communication capability and includes a rate at which data is transmitted and received.

In response to receiving the production instruction from the administrator, the build environment management server 100 requests the service provision server 200 to produce a virtual server. This production request includes the performance information specified by the production instruction. In response to receiving the production request, the service provision server 200 produces the virtual server having the performance specified by the performance information included in the production request. As a result, the virtual server is formed in the service provision server 200.

The administrator operates the administrator PC 300 to instruct the build environment management server 100 to set a build environment. The build environment setting instruction includes tool information for specifying a tool to be used by the virtual server as the build environment. Although not limited, the tool information is the information for specifying a Toolchain. Toolchain includes a compiler, a linker and a debugger.

In response to the build environment setting instruction from the administrator, the build environment management server 100 sets the build environment in the virtual server formed in the service provision server 200. This setting instruction includes the tool information. The virtual server formed in the service provision server 200 sets the Toolchain specified by the tool information in accordance with the setting instruction accepted from the build environment management server 100.

The administrator operates the administrator PC 300 to instruct the build environment management server 100 to execute a software build. The build instruction here is referred to as an administrator build instruction.

The administrator build instruction includes a build condition. The build condition include information for specifying software to be built, a version of the software, and information for specifying a repository in which source files that configure the software are stored. A source file is data in which a source code is written.

In response to the administrator build instruction, the build environment management server 100 transmits a command for instructing the virtual server formed in the service provision server 200 to execute a full build. This command includes a build condition. In response to receiving the command, the virtual server formed in the service provision server 200 executes a full build in accordance with the build condition included in the command. Specifically, the virtual server acquires a source file defined based on the build condition from a repository defined based on the build condition. Here, because the source file is stored in the repository of the version management server 201, the virtual server formed in the service provision server 200 acquires the source file from the version management server 201. Then, the virtual server formed in the service provision server 200 executes a full built using the source file.

When completing a full build using the source file, the virtual server formed in the service provision server 200 transmits build result data to the version management server 201. The build result data includes an object file, a build period of time, the number of bugs, and error information about an error in case of error occurrence.

When receiving the build result data from the virtual server formed in the service provision server 200, the version management server 201 stores the build result data in the repository. Thus, the build history in regard to the software is updated. Further, the version management server 201 stores the object file in the repository.

On the other hand, after the virtual server executes a full build and transmits the build result data to the version management server 201, the service provision server 200 stores a virtual machine image and turns off the power of the virtual server. The virtual machine image is an image of the virtual server in which the build environment is set, and is a launch template that has information required for activating the virtual server in which the build environment is set.

The build environment management server 100 acquires a machine image name for identifying the virtual machine image from the service provision server 200, and stores the acquired machine image name in the HDD 104. Then, the build environment management server 100 associates the software to be built with the virtual machine image. Association data in which a software name for identifying the software, a version and a machine image name are associated with one another is stored in the HDD 104.

The service provision server 200 counts a use period of time from the time when the virtual server is produced until the time when power is turned off, calculates a charging amount based on a unit price per unit time defined according to the performance of the virtual server and a use period of time, and charges the build environment management server 100. The build environment management server 100 accesses the service provision server 200 using an ID issued by the service provision server 200. The service provision server 200 charges the ID that has made an access. This ID may be managed by the build environment management server 100 or may be managed by the administrator who operates the administrator PC 300.

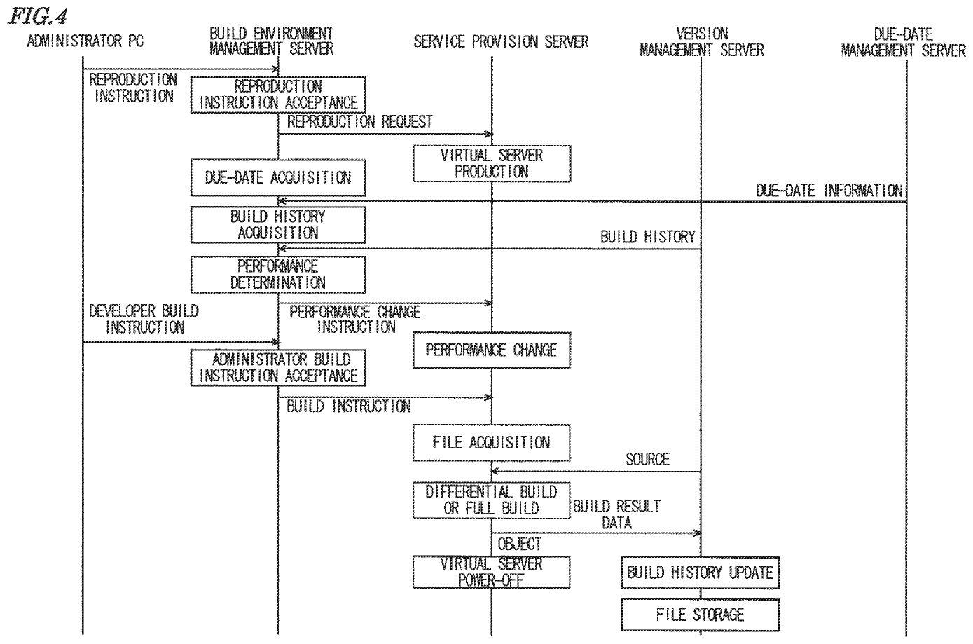

FIG. 4 is a second sequence diagram illustrating the sequence of a software build in the software build system. In FIG. 4, the processes respectively executed and the information pieces respectively transmitted and received, by the developer PC 300A, the build environment management server 100, the service provision server 200, the version management server 201 and the due-date management server 202, are illustrated. In FIG. 4, an elapse of time is illustrated in the direction from the top to the bottom. Further, a source file that configures the software produced by the developer PC 300A here, among the developer PCs 300A to 300C, is stored in the repository of the version management server 201, by way of example.

With reference to FIG. 4, the developer A operates the developer PC 300A to instruct the build environment management server 100 to reproduce a virtual server. The reproduction instruction includes a machine image name. As illustrated in FIG. 3, the build environment management server 100 associates a software name, a version of software, and a machine image name of a virtual machine image of a virtual server that is produced to build the software of the version. Therefore, the developer PC 300A acquires, from the build environment management server 100, a table in which source file names, versions and machine image names are associated with one another, and displays the table. Thus, the developer A can specify a machine image name corresponding to a virtual server for building software of a version developed by the developer A. Further, the developer A can specify a version of the software developed by the developer A based on the software version history managed by the version management server 201. In response to the input, to the developer PC 300A, of a machine image name determined by the developer A with reference to the table, the developer PC 300A transmits a virtual server reproduction instruction to the build environment management server 100.

In response to the reproduction instruction from the developer A, the build environment management server 100 requests the service provision server 200 to reproduce the virtual server. This virtual server reproduction request includes the machine image name included in the reproduction instruction. In response to receiving the virtual server reproduction request, the service provision server 200 produces the virtual server in which a build environment is set, by using the virtual machine image specified by the machine image name. As described with reference to FIG. 3, this virtual server has the performance determined by the administrator and has the build environment set by the administrator. The build environment management server 100 acquires, from the service provision server 200, a virtual server name for identifying the virtual server reproduced by the service provision server 200, and transmits the virtual server name to the developer PC 300A. Thus, the developer A can specify the virtual server formed in the service provision server 200.

The build environment management server 100 acquires a due date of software. The service provision server 200 acquires a due date of software from the due-date management server 202. Then, the build environment management server 100 acquires a build history. The build environment management server 100 acquires the build history related to software from the version management server 201.

The build environment management server 100 determines the performance of the virtual server. The build environment management server 100 determines the performance of the virtual server based on the due date of software and the build history. Then, the build environment management server 100 transmits an instruction for changing the performance of the virtual server formed in the build environment management server 100 to the service provision server 200. This performance change instruction is transmitted using a Command Line Interface (CLI). The service provision server 200 that receives the performance change instruction changes the performance of a previously formed virtual server to the performance specified by the performance change instruction.

The developer A operates the developer PC 300A to instruct the build environment management server 100 to execute a software build. The build instruction here is referred to as a developer build instruction. The developer build instruction includes a virtual server name.

In response to receiving the developer build instruction from the developer PC 300A, the build environment management server 100 specifies the software to be built. In the present embodiment, because the virtual server name includes a software name and a version, a source file to be built is specified based on the software name and the version associated with the virtual server name. Note that the developer may specify the software.

The build environment management server 100 transmits a command for providing an instruction for executing a software build to the virtual server formed in the service provision server 200. This command includes a build condition. In response to receiving the command, the virtual server formed in the service provision server 200 executes a software build in accordance with the build condition included in the command. Specifically, the virtual server acquires, from a repository defined by the build condition, a source files that configures the software defined by the build condition. Here, because the source file is stored in the repository of the version management server 201, the virtual server formed in the service provision server 200 acquires the source file from the version management server 201. Then, the virtual server formed in the service provision server 200 executes a built using the source file. The build condition includes whether a software build is a full build or a differential build. In a case in which a full build is defined by a build condition, the virtual server executes a full build using a source file. In a case in which a differential build is defined by a build condition, the virtual server executes a differential build using a source file.

When a software build is completed, the virtual server formed in the service provision server 200 transmits build result data to the version management server 201. The build result data includes an object file, a build period of time, the number of bugs, and error information in case of an error occurrence.

When receiving the build result data from the virtual server formed in the service provision server 200, the version management server 201 stores the build result data in the repository. Thus, a build history in regard to a source code is updated. Further, the version management server 201 stores an object file in the repository.

On the other hand, after the virtual server executes a software build and transmits the build result data to the version management server 201, the service provision server 200 turns off the power of the virtual server.

The service provision server 200 counts a use period of time from the time when the virtual server is produced until the time when the power is turned off, calculates a charging amount based on a unit price per unit time defined according to the performance of the virtual server and the use period of time, and charges the build environment management server 100.

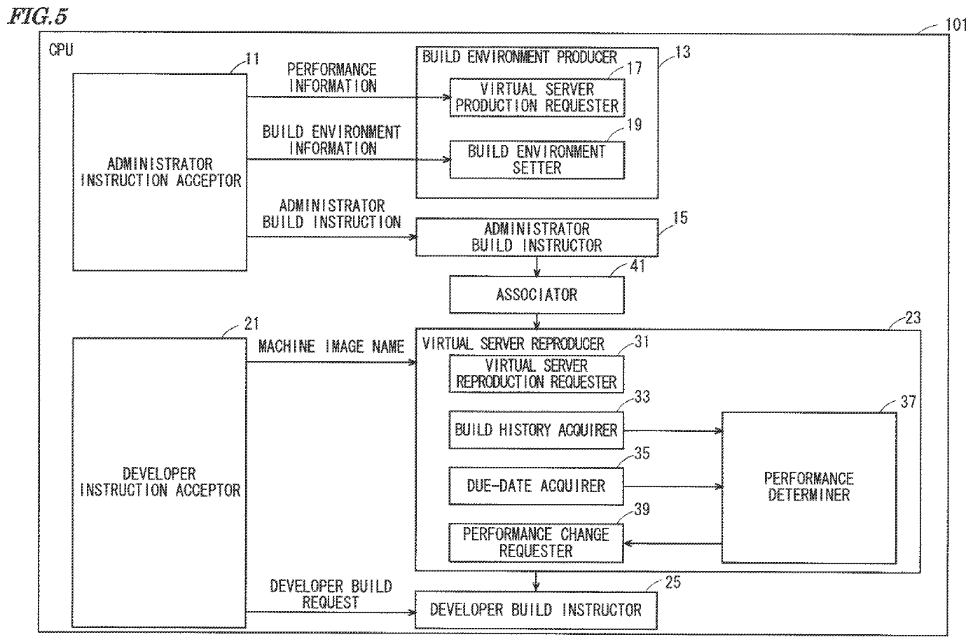

FIG. 5 is a block diagram illustrating one example of the functions of the CPU included in the build environment management server. The functions illustrated in FIG. 5 are implemented in the CPU 101 included in the build environment management server 100 by execution of a software development assistance program by the CPU 101. Further, a continuous integration tool is installed in the build environment management server 100. The continuous integration tool is a tool for automatically executing a software build. One example of the continuous integration tool includes Jenkins. Therefore, the build environment management server 100 executes a process of building a source file in cooperation with a virtual server formed as a build server in the service provision server 200.

With reference to FIG. 5, the CPU 101 included in the build environment management server 100 includes an administrator instruction acceptor 11, a build environment producer 13, an administrator build instructor 15, a developer instruction acceptor 21, a virtual server reproducer 23, a developer build instructor 25 and an associator 41.

The administrator instruction acceptor 11 controls the communication section 105 to communicate with the administrator PC 300. The administrator instruction acceptor 11 receives, from the administrator PC 300, an instruction input by the administrator to the administrator PC 300.

The administrator instruction acceptor 11 transmits a performance input screen for input of the performance of the virtual server to the administrator PC 300, and receives performance information representing the performance input by the administrator in accordance with the performance input screen from the administrator PC 300. The administrator instruction acceptor 11 outputs the performance information to the build environment producer 13.

The administrator instruction acceptor 11 transmits an environment setting screen for designation of a build environment to be set in the virtual server, and receives build environment information input by the administrator in accordance with the environment setting screen from the administrator PC 300. The build environment information is set in the virtual server for execution of a process of a software build. The build environment information includes tool information and information designating the version management server 201, for example.

The build environment producer 13 communicates with the service provision server 200 and utilizes a service provided by the service provision server 200. The build environment producer 13 includes a virtual server production requester 17 and a build environment setter 19. In response to receiving the performance information from the administrator instruction acceptor 11, the virtual server production requester 17 requests the service provision server 200 to produce a virtual server. For example, the build environment producer 13 transmits a command for production of a virtual server using a CLI. The service provision server 200 that receives the command produces a virtual server having the performance specified by the performance information included in the command, and makes the virtual server available to the build environment management server 100.

In response to receiving the build environment information from the administrator instruction acceptor 11, the build environment producer 13 sets a build environment in the virtual server formed in the service provision server 200. For example, the build environment producer 13 operates the virtual server formed in the service provision server 200, and sets the build environment specified by the build environment information in the virtual server.

The administrator instruction acceptor 11 sends an administrator build instruction screen to the administrator PC 300 and receives an administrator build instruction from the administrator PC 300.

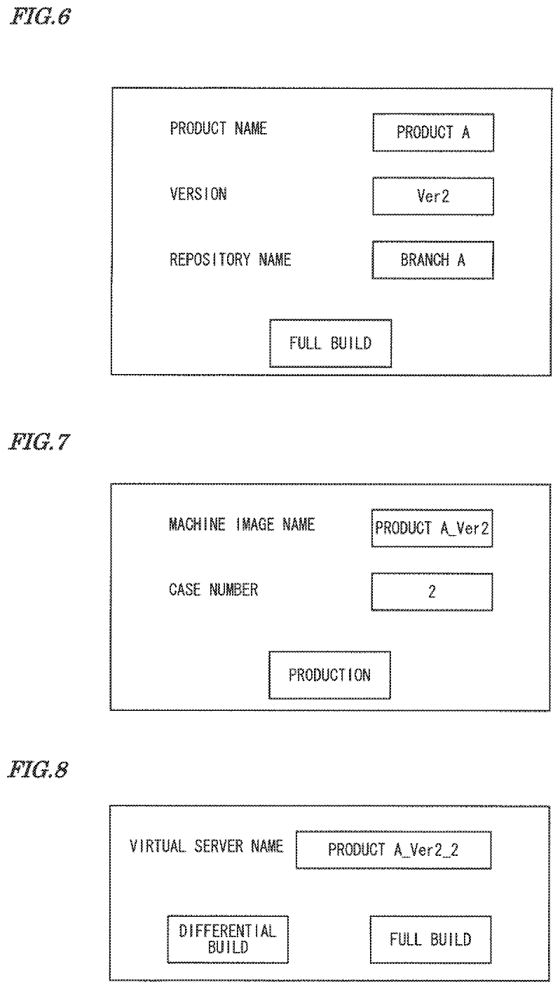

FIG. 6 is a diagram illustrating one example of the administrator build instruction screen. With reference to FIG. 6, the administrator build instruction screen includes an area for input of a file name of a source file, an area for input of a source file version, an area for input of repository information, and an execution instruction button in which the character string for a full build is indicated. When the execution instruction button is designated with each of a source file name, a source file version and repository information being input, the administrator PC 300 transmits an administrator build instruction to the build environment management server 100. The administrator build instruction includes the source file name, the source file version and the repository information specifying the repository in which the source file is stored. Here, software is configured by one source file, by way of example. Therefore, the source file name in FIG. 6 is the information that specifies the software.

Referring back to FIG. 5, in response to receiving the administrator build instruction from the administrator PC 300, the administrator instruction acceptor 11 outputs the administrator build instruction to the administrator build instructor 15. In response to receiving the administrator build instruction, the administrator build instructor 15 instructs the virtual server formed in the service provision server 200 to execute a build. Specifically, the administrator build instructor 15 acquires the source file specified by the source file name and the version included in the administrator build instruction from the repository specified by the repository information, and inputs a full-build instruction to the virtual server. Thus, the source file is built by the virtual server formed in the service provision server 200, and build result data is stored in the repository. When a build is completed by the virtual server, the administrator build instructor 15 outputs a completion instruction to the associator 41. The completion instruction includes the source file name.

In response to receiving the completion instruction, the associator 41 instructs the service provision server 200 to store a virtual machine image of the virtual server and turn off the power of the virtual server. When storing the virtual machine image of the virtual server, the service provision server 200 returns a machine image name for identifying the virtual machine image. The associator 41 associates the virtual machine image with software. Specifically, the associator 41 outputs, to the virtual server reproducer 23, the association data in which the machine image name, the file name of the source file and the source file version are associated with one another.

The developer instruction acceptor 21 controls the communication section 105 to communicate with the developer PC 300A. The developer instruction acceptor 21 receives, from the administrator PC 300A, an instruction that is input by the developer A to the developer PC 300A. The developer instruction acceptor 21 transmits a reproduction instruction screen to the developer PC 300A and receives a reproduction instruction from the developer PC 300A.

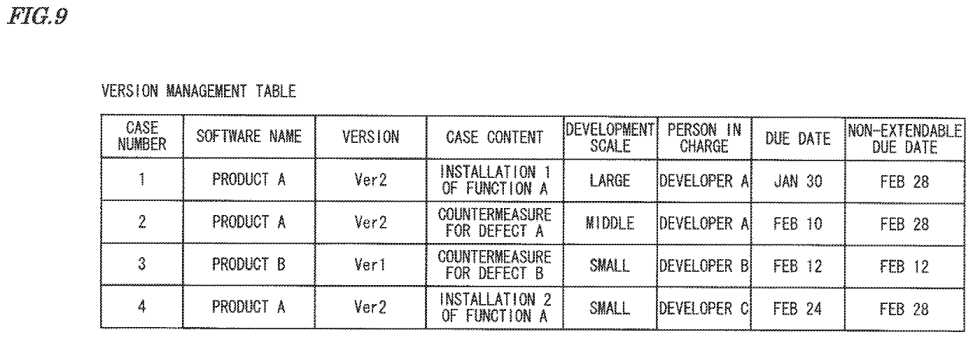

FIG. 7 is a diagram illustrating one example of the reproduction instruction screen. With reference to FIG. 7, the reproduction instruction screen includes an area for input of a machine image name, an area for input of a case number and an execution instruction button in which the character string for production is indicated. When the execution instruction button is designated with a machine image name and a case number being input, the administrator PC 300 transmits the reproduction instruction to the build environment management server 100. The reproduction instruction includes the machine image name and the case number.

Referring back to FIG. 5, in response to receiving the reproduction instruction from the administrator PC 300, the administrator instruction acceptor 11 outputs the received reproduction instruction to the virtual server reproducer 23.

In response to receiving the reproduction instruction, the virtual server reproducer 23 produces a virtual server in the service provision server 200. The virtual server reproducer 23 includes a virtual server reproduction requester 31, a build history acquirer 33, a due-date acquirer 35, a performance determiner 37 and a performance change requester 39.

In response to receiving the reproduction instruction, the virtual server reproduction requester 31 requests the service provision server 200 to reproduce the virtual server. Specifically, the virtual server reproduction requester 31 inputs, to the service provision server 200, a virtual server reproduction command that includes a machine image name and a case number included in the reproduction instruction. Thus, the service provision server 200 produces the virtual server based on a virtual machine image specified by the machine image name. The service provision server 200 returns a virtual server name for identifying the produced virtual server. At this time, the service provision server 200 adds a case number to the virtual server name. The number of the produced same virtual servers may be equal to the number of cases. The virtual server reproduction requester 31 transmits the virtual server name to the developer PC 300A. Therefore, the developer A can identify the name of the virtual server produced in the service provision server 200.

In response to receiving the reproduction instruction, the build history acquirer 33 acquires build history information from the version management server 201. The build history acquirer 33 receives association data from the associator 41. Association data associates a machine image name, a file name of a source file, and a source file version to one another. The build history acquirer 33 specifies a source file name and a version associated with the machine image name included in the reproduction instruction by the association data. The build history acquirer 33 acquires the build result data corresponding to the source file name and the version from the version management server 201. The build history acquirer 33 outputs the build result data to the performance determiner 37.

The due-date acquirer 35 specifies the source file name and the version associated with the machine image name included in the reproduction instruction by the association data. The due-date acquirer 35 acquires the due date corresponding to the source file name and the version from the due-date management server 202. The due-date acquirer 35 outputs the due date to the performance determiner 37.

The performance determiner 37 determines the performance of the virtual server. The performance determiner 37 determines a performance level of the virtual server based on the due date and the build result data. Details of a performance level and a process of determining a performance level by the performance determiner 37 will be described below. The performance determiner 37 outputs the determined performance level to the performance change requester 39.

The performance change requester 39 transmits, to the service provision server 200, a command for providing an instruction for changing the performance of the virtual server to the performance determined by the performance level received from the performance determiner 37. In response to receiving the command, the service provision server 200 changes the performance of the virtual server.

The developer instruction acceptor 21 transmits a developer build instruction screen to the developer PC 300A and receives a developer build instruction from the developer PC 300A.

FIG. 8 is a diagram illustrating one example of the developer build instruction screen. With reference to FIG. 8, the developer build instruction screen includes an area for input of a virtual server name, a differential build execution instruction button in which the character string for a differential build is indicated, and a full build execution instruction button in which the character string for a full build is indicated.

When either the differential build execution instruction button or the full build execution instruction button is designated with a virtual server name being input, the developer PC 300A transmits a developer build instruction to the build environment management server 100. The developer build instruction includes a virtual server name and a build type. The build type indicates either a differential build or a full build.

Referring back to FIG. 5, in response to receiving the developer build instruction from the developer PC 300A, the developer instruction acceptor 21 outputs the developer build instruction to the developer build instructor 25. In response to receiving the developer build instruction, the developer build instructor 25 instructs the virtual server formed in the service provision server 200 to execute either a differential build or a full build. The developer build instructor 25 receives a source file name and a version corresponding to the virtual server from the virtual server reproducer 23. The developer build instructor 25 acquires a source file specified by the source file name and the version from a repository specified by repository information, and inputs a build instruction to the virtual server. Thus, a source file is built by the virtual server formed in the service provision server 200, and build result data is stored in the repository. When a build is completed by the virtual server, the developer build instructor 25 instructs the service provision server 200 to turn off the power of the virtual server.

### <Production of Build History Table>

The build history acquirer 33 produces a version management table based on version management information acquired from the version management server 201 and due-date information acquired from the due-date management server 202. Further, the build history acquirer 33 produces a build history table based on the version management table and build result data acquired from the version management server 201.

FIG. 9 is a diagram illustrating one example of the version management table. With reference to FIG. 9, the version management table includes a plurality of version management records. A version management record is produced for each case number. A version management record includes an item for a case number, an item for a software name, an item for a version, an item for case content, an item for a development scale, an item for a person in charge, an item for a due date and an item for a non-extendable due date.

In the item for a software name, the information for identifying software to be developed is set. In the item for a version, a software version specified by a software name that is set in the item for a software name is set. Software to be developed is specified by a combination of a software name and a version. In the item for case content, the content of software to be developed by a developer is set. For example, the case content indicates a portion to be added in a case in which a portion of software is added, and indicates a portion to be modified and modification content in a case in which software is modified.

In the item for a case number, the information provided to a set of a software name, a version and case content is set. The development scale of software identified by a case number is set in the item for a development scale. The development scale includes the size of a source file or the number of source files. Here, the development scale is set to one of large, medium and small. For example, the development scale is defined by classification of the number of lines to be scheduled to written in a program into three based on threshold values.

In the item for a person in charge, the information for identifying a developer who is in charge of the development work of the software specified by the item for a case number is set.

In the item for a due date, a second-type due date of the software specified by a case number is set. An extendable due date is set as a second-type due date. In the item for a non-extendable due date, a first-type due date of the software specified by a case number is set. A date that cannot be extended is set as a first-type due date set in the item for a non-extendable due date. A second-type due date may be set or may be not set.

According to the version management table illustrated in FIG. 9, the number of developers in charge of developing software the software name of which is a product A and the version of which is Ver2 is two, and the number of developers in charge of developing software the software name of which is a product B and the version of which is Ver1 is one.

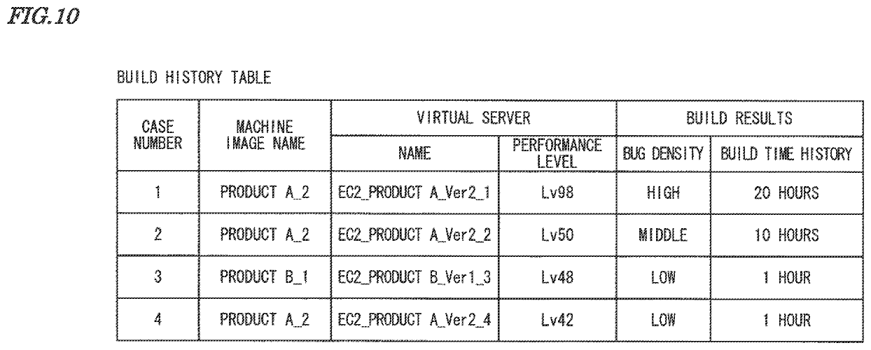

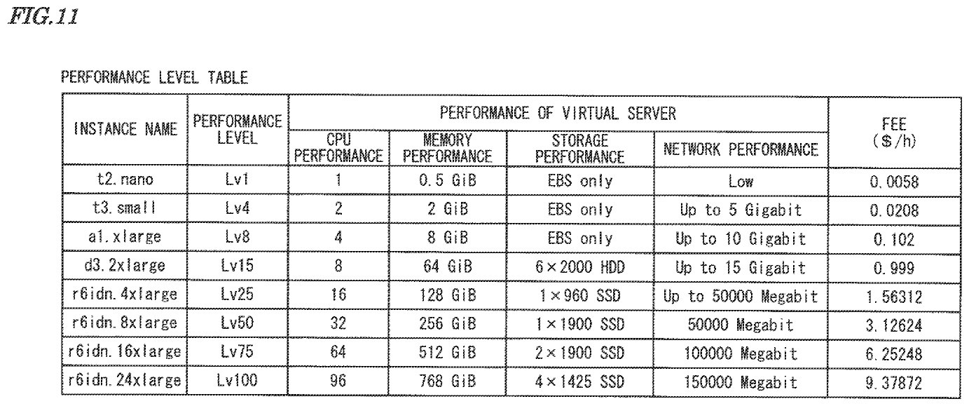

FIG. 10 is a diagram illustrating one example of a build history table. With reference to FIG. 10, the build history table includes a build history record corresponding to build result data produced by the version management server 201 in response to execution of a software build.

A build history record includes an item for a case number, an item for a machine image name, an item for a virtual server and an item for build results. In the item for a case number, the information set in the item for a case number of the version management table illustrated in FIG. 9 is set. Therefore, a build history record is produced in regard to a build of software having a software name set in the item for a software name and a version set in the item for a version, in FIG. 9.

In the item for a machine image name, a machine image name for identification by the administrator of a machine image of a produced virtual server in which a build environment is set, is set. The item of a virtual server includes an item for a name and an item for a performance level. In the item for a name, the name of a virtual server reproduced from a machine image by the service provision server 200 is set. In the item for a performance level, a performance level of a virtual server is set.

In the item for build results includes an item for a bug density and an item for a build time history. In the item for a bug density, a level of a bug density discovered as a result of execution of a build by the virtual server is set. Here, the level of a bug density is set to the three levels of high, middle and low. A bug density is defined by classification of a bug density into three levels based on threshold values.

In the item for a build time history, a period of time from the time when the virtual server starts a build until the time when the virtual server ends the build. In regard to a period of time set in the item for a build time history, a period of time required for an immediately preceding build, or an accumulated period of time may be set in a case in which a build is repeated multiple times.

### <Determination of Performance Level>

The performance determiner 37 stores a performance level table in the HDD 104. The performance level table is a table that defines the relationship between a performance level of a virtual server, and performance of a virtual server and a fee. Here, the relationship is defined such that the higher a performance level, the higher the performance of a virtual server, and the higher a fee.

FIG. 11 is a diagram illustrating one example of a performance level table. With reference to FIG. 11, the performance level table includes performance level records respectively corresponding to a plurality of performance levels. A performance level record includes an item for an instance name, an item for a performance level, an item for performance of a virtual server and an item for a fee.

In the item for an instance name, a name of a virtual server defined by the service provision server 200 is set. In the item for a performance level, any one of a plurality of predetermined performance levels is set. Here, 100 levels from 1 to 100 are defined for the performance level, by way of example. In the diagram, eight examples in which the performance levels are Lv1, 4, 8, 15, 25, 30, 75 and 100 are illustrated, and performance level records for the other performance levels are not illustrated. Lv100 indicates the highest performance level, and Lv1 indicates the lowest performance level.

The item for performance of a virtual server includes an item for CPU performance, an item for memory performance, an item for storage performance and an item for network performance. In the item for CPU performance, a value indicating the CPU performance of a virtual server is set. In the present embodiment, the CPU performance indicates the number of cores in the CPU. Note that a processing speed may be used to indicate the CPU performance. In the item for memory performance, the size of a main memory is set.

In the item for storage performance, the size of a non-volatile memory is set. The type of a non-volatile memory may be set as storage performance. In the item for network performance, a communication speed is set.

In the item for a fee, a fee requested by the business operator who manages the service provision server 200 is set when the service provision server 200 supplies a virtual server having the performance of a value set in the item for performance of a virtual server. A fee indicates a price per unit time.

The performance determiner 37 determines a performance level based on a due date of software to be built. The performance determiner 37 determines a performance level such that the shorter the period of time between a current date and a due date, the higher the performance level.

Further, in a case in which build result data is present for the software to be built, the performance determiner 37 determines a performance level based on the build result data in addition to a due date with reference to a build history table stored in the HDD 104. The build result data includes a build time history and a bug density. The performance determiner 37 determines a performance level such that the longer a build period of time, the higher the performance level. The performance determiner 37 determines a performance level such that the higher a bug density, the higher the performance level. Further, the performance determiner 37 determines a performance level such that the larger the number of developers in charge of developing software to be built, the higher the performance level.

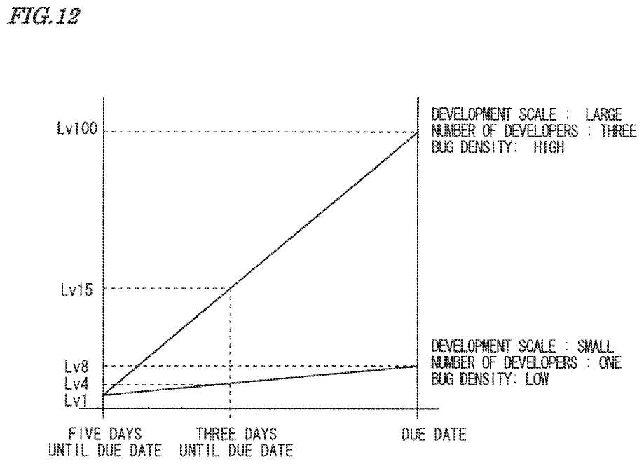

FIG. 12 is a graph illustrating one example of the relationship between a performance level and a due date. With reference to FIG. 12, the abscissa indicates a period of time until a due date, and the ordinate indicates a performance level. FIG. 12 illustrates the straight line representing the relationship between a due date and a performance level in a case in which the development scale is small, the number of developers is one, and the bug density is low, and illustrates the straight line representing the relationship between a due date and a performance level in a case in which the development scale is large, the number of developers is three, and the bug density is high. In regard to both of the two straight lines, the shorter a period until a due date, the higher a performance level.

Straight lines representing a development scale, the numbers of developers and a bug density that are different from the above-mentioned two examples are located in the range between the two straight lines.

Further, the inclination of a graph indicates an increase rate. An increase rate indicates a performance difference that is increased per unit period. A performance difference is a difference between a performance level at the start of a unit time and a performance level at the end of the unit time. The higher a development scale, the number of developers and a bug density, the higher an increase rate. An increase rate W may be defined using the following formula (1) in which a development scale X, the number of developers Y and a bug density Z are used.

W=aX+bY+cZ (1)

Note that a, b and c are predetermined constants.

When no build history is present for software to be built, the performance determiner 37 determines a performance level based on a period until a due date, using a predetermined value as a performance difference that is increased per unit period.

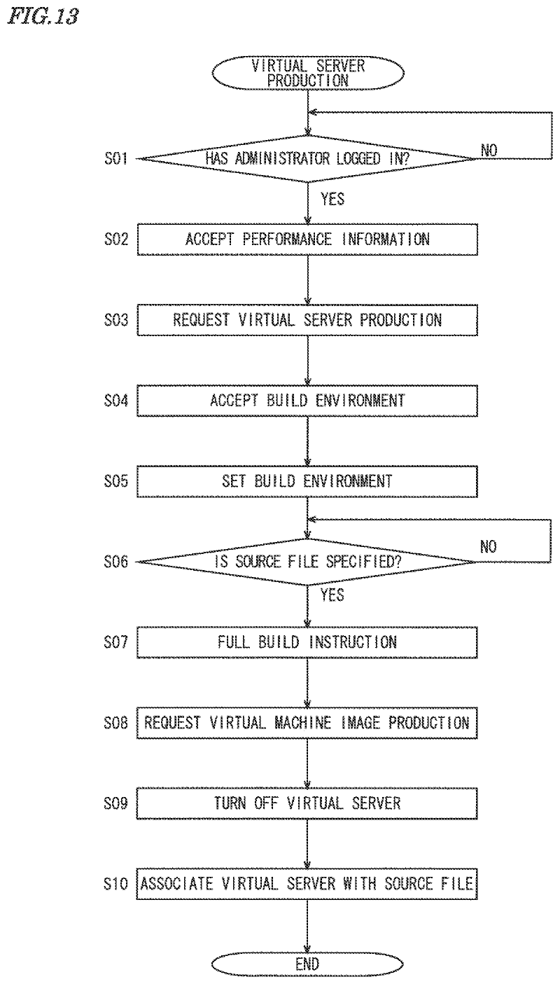

FIG. 13 is a flowchart illustrating one example of a flow of a virtual server production process. The virtual server production process is a process executed by the CPU 101 when the CPU 101 included in the build environment management server 100 executes the software development assistance program. With reference to FIG. 13, the CPU 101 included in the build environment management server 100 determines whether a login of an administrator has been detected (step S01). The process waits until a login of an administrator is detected (NO in the step S01). If a log in of an administrator is detected (YES in the step S01), the process proceeds to the step S02.

In the step S02, performance information is accepted, and the process proceeds to the step S03. The CPU 101 transmits a performance input screen to the administrator PC 300, and receives, from the administrator PC 300, performance information representing the performance that is input to the administrator PC 300 by the administrator in accordance with the performance input screen. The performance information includes the number of cores of a CPU, a size of a main memory, communication capability and a size of a non-volatile memory.

In the step S03, the service provision server 200 is requested to produce a virtual server, and the process proceeds to the step S04. For example, the CPU 101 uses a CLI to transmit a command for producing a virtual server to the service provision server 200. The service provision server 200 that receives the command produces the virtual server having the performance included in the command.

In the step S04, a build environment is accepted, and the process proceeds to the step S05. The CPU 101 transmits an environment setting screen to the administrator PC 300, and receives build environment information representing a build environment that is input to the administrator PC 300 by the administrator in accordance with the environment setting screen from the administrator PC 300. The build environment information includes information specifying a compiler, a library, a linker, a debugger and the version management server 201, for example.

In the step S05, the build environment is set in the virtual server formed in the service provision server 200, and the process proceeds to the step S06. For example, the CPU 101 operates the virtual server formed in the service provision server 200 and sets the build environment specified by the build environment information in the virtual server.

In the step S06, whether a source file has been specified is determined. The process waits until a source file is specified (NO in the step S06). If a source file is specified (YES in the step S06), the process proceeds to the step S07. The CPU 101 transmits the administrator build instruction screen illustrated in FIG. 6 to the administrator PC 300, and receives an administrator build instruction from the administrator PC 300. The administrator build instruction includes a file name of a source file, a version of the source file and repository information.

In the step S07, the virtual server which is formed in the service provision server 200 and in which the build environment is set is instructed to execute a full build, and the process proceeds to the step S08. The CPU 101 acquires the source file specified by the source file name and the version from the repository specified by the repository information, and inputs a build instruction to the virtual server. Thus, the source file is built by the virtual server formed in the service provision server 200, and build result data is stored in the repository.

In the step S08, production of a virtual machine image is requested, and the process proceeds to the step S09. The CPU 101 transmits a command for storing the virtual machine image of the virtual server to the service provision server 200. When completing storage of the virtual machine image, the service provision server 200 returns a machine image name for identifying the virtual machine image. In the step S09, power of the virtual server is turned off, and the process proceeds to the step S10. The CPU 101 transmits, to the service provision server 200, a command for turning off the power of the virtual server.

In the step S10, the virtual server and the software are associated with each other, and the process ends. The CPU 101 produces association data in which the machine image name of the virtual machine image, the file name of the source file and the version of the source file are associated with one another, and stores the association data in the HDD 104.

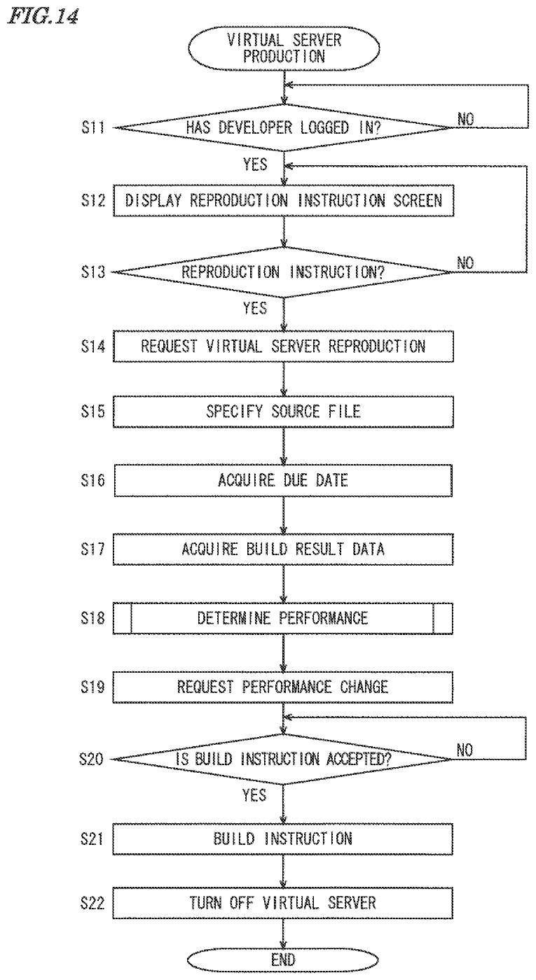

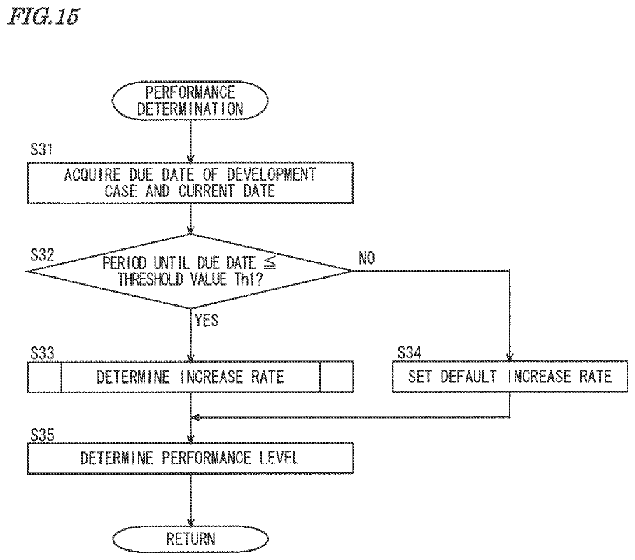

FIG. 14 is a flowchart illustrating one example of a flow of a virtual server reproduction process. The virtual server reproduction process is a process executed by the CPU 101 included in the build environment management server 100 when the CPU 101 executes the software development assistance program. With reference to FIG. 14, the CPU 101 included in the build environment management server 100 determines whether a login of a developer has been detected. The process waits until the CPU 101 detects a login of any of the developers A to C (NO in the step S11). If a login of any of the developers A to C is detected (YES in the step S11), the process proceeds to the step S12. A login of the developer A is detected, by way of example.

In the step S12, the CPU 101 causes the developer PC 300A to display a reproduction instruction screen, and the process proceeds to the step S13. The CPU 101 transmits the reproduction instruction screen illustrated in FIG. 7 to the developer PC 300A, and causes the developer PC 300A to display the reproduction instruction screen.

In the step S13, whether a reproduction instruction has been accepted is determined. The process waits until a reproduction instruction is accepted (NO in the step S13). When the reproduction instruction is accepted (YES in the step S13), the process proceeds to the step S14. The reproduction instruction includes a machine image name and a case number.

In the step S14, the service provision server 200 is requested to reproduce a virtual server, and the process proceeds to the step S15. The CPU 101 transmits a command for reproducing the virtual server to the service provision server 200. The reproduction command includes the machine image name and the case number included in the reproduction instruction accepted in the step S12. Thus, the service provision server 200 produces the virtual server based on a virtual machine image specified by the machine image name.

In the step S15, a source file to be built is specified, and the process proceeds to the step S16. The CPU 101 acquires build history information from the version management server 201, and specifies a source file based on association information. The association data associates the machine image name, the file name of the source file and a source file version to one another. The CPU 101 specifies a source file, specified by the source file name and the version associated, by the association data, with the machine image name included in the reproduction instruction accepted in the step S13, as a source file to be built.

In the step S16, the due date of the source file is acquired, and the process proceeds to the step S17. The CPU 101 acquires the due date of the source file from the due-date management server 202.

In the step S17, build result data is acquired, and the process proceeds to the step S18. The CPU 101 acquires build result data representing the build history of the source file from the version management server 201.

In the step S18, a performance determination process is executed, and the process proceeds to the step S19. Although details of the performance determination process will be described below, the performance determination process is a process of determining the performance of a virtual server which is formed in the service provision server 200 and in which a build environment is set.

In the step S19, a request for changing the performance of the virtual server is made, and the process proceeds to the step S20. The CPU 101 transmits, to the service provision server 200, a command for providing an instruction to change the performance of the virtual server to the performance determined in the step S18. In response to receiving the command, the service provision server 200 changes the performance of the virtual server.

In the step S20, whether a build instruction has been accepted is determined. The CPU 101 transmits the developer build instruction screen illustrated in FIG. 8 to the developer PC 300A, and accepts the build instruction by receiving the build instruction from the developer PC 300A. The process waits until the build instruction is accepted (NO in the step S20). If the build instruction is accepted (YES in the step S20), the process proceeds to the step S21. The build instruction includes a virtual server name and a build type. The build type indicates either a differential build or a full build.

In the step S21, the virtual server formed in the service provision server 200 is instructed to execute a build. The CPU 101 instructs the virtual server formed in the service provision server 200 to execute a full build or a differential build of the source file specified in the step S15. Thus, the source file is built by the virtual server formed in the service provision server 200, and build result data is stored in the repository.

In the next step S22, the power of the virtual server is turned off, and the process ends. The CPU 101 transmits, to the service provision server 200, a command for turning off the power of the virtual server.

FIG. 15 is a flowchart illustrating one example of a flow of the performance determination process. The performance determination process is a process that is executed in the step S18 of the virtual server reproduction process. With reference to FIG. 15, the CPU 101 included in the build environment management server 100 acquires a due date of a development case and a current date (step S31), and the process proceeds to the step S32. The CPU 101 calculates a period until the due date.

In the step S32, whether the period until the due date is equal to or smaller than a threshold value Th1. If the period until the due date is equal to or smaller than the threshold value Th1, the process proceeds to the step S33. If not, the process proceeds to the step S34.

In the step S33, an increase rate determination process is executed, and the process proceeds to the step S34. In the step S34, an increase rate is set to a default value, and the process proceeds to the step S35. The default increase rate is defined based on at least one of a development scale, a bug density, a build time history and the number of developers.

In the step S35, a performance level is determined, and the process returns to the virtual server reproduction process. In a case in which the process proceeds from the step S33, a performance level is determined based on an increase rate determined in the step S33. In a case in which the process proceeds from the step S34, a performance level is determined based on a default increase rate. The increase rate indicates an inclination of the graph illustrated in FIG. 12.

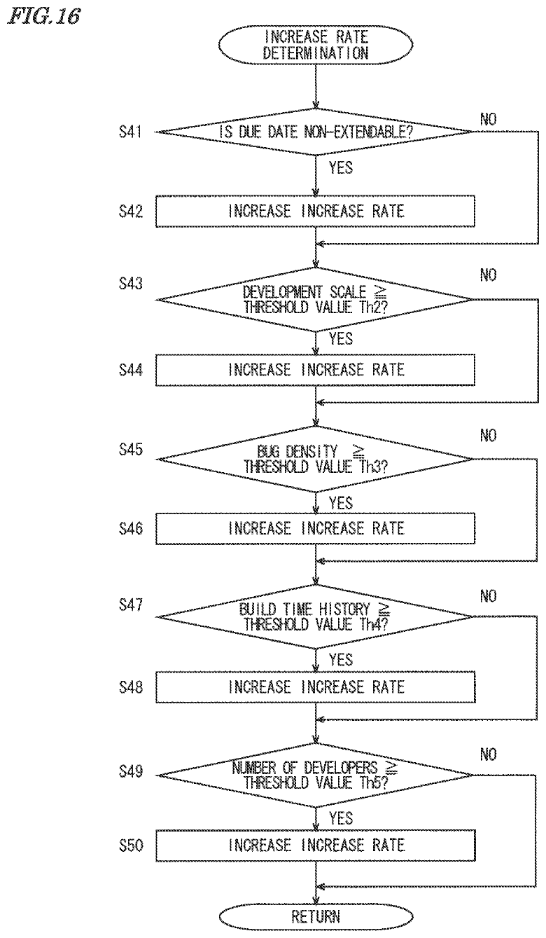

FIG. 16 is a flowchart illustrating one example of a flow of an increase rate determination process. The increase rate determination process is a process that is executed in the step S33 of the performance determination process. With reference to FIG. 16, whether a due date is a non-extendable due date is determined by the CPU 101 included in the build environment management server 100 (step S41). If a due date that is determined to be equal to or smaller than a threshold value Th1 in the step S32 of the performance determination process is a non-extendable due date, the process proceeds to the step S42. If not, the process skips the step S42 and proceeds to the step S43. In the step S42, the CPU 101 increases an increase rate, and the process proceeds to the step S43. The CPU 101 determines a value larger than the default increase rate as the increase rate.

In the step S43, whether a development scale is equal to or larger than a threshold value Th2 is determined. If the development scale is equal to or larger than the threshold value Th2, the process proceeds to step S44. If not, the process skips the step S44 and proceeds to the step S45. In the step S44, the CPU 101 increases the increase rate, and the process proceeds to the step S45. A value larger than the increase rate that is determined before the step S43 is performed is determined as the increase rate.

In the step S45, whether a bug density is equal to or larger than a threshold value Th3 is determined. If the bug density is equal to or larger than the threshold value Th3, the process proceeds to the step S46. If not, the process skips the step S46 and proceeds to the step S47. In the step S46, the CPU 101 increases the increase rate, and the process proceeds to the step S47. A value larger than an increase rate that is determined before the step S46 is performed is determined as the increase rate.

In the step S47, whether a build time history is equal to or larger than a threshold value Th4 is determined. If the build time history is equal to or larger than the threshold value Th4, the process proceeds to the step S48. If not, the process skips the step S48 and proceeds to the step S49. In the step S48, the CPU 101 increases the increase rate, and the process proceeds to the step S49. A value larger than an increase rate that is determined before the step S48 is performed is determined as the increase rate.

In the step S49, whether the number of developers is equal to or larger than a threshold value Th5 is determined. If the number of developers is equal to or larger than the threshold value Th5, the process proceeds to the step S50. If not, the process skips the step S50 and returns to the performance determination process. In the step S50, the CPU 101 increases the increase rate, and the process returns to the performance determination process. A value larger than an increase rate that is determined before the step S50 is performed is determined as the increase rate.

As described above, the software build system 1 in the present embodiment includes the build environment management server 100 and the service provision server 200 that provides a service for supplying a virtual server, and the build environment management server 100 acquires a due date determined for software from the due-date management server 202, associates the virtual server provided by the service provision server 200 with the software, determines the performance of the virtual server based on information about the software, and requests the service provision server 200 to change the performance of the virtual server to the determined performance. Therefore, a period of time required for a software build in the virtual server is adjusted based on the information about the software. Further, in a case in which varying depending on the performance of the virtual server, a price for receiving the provision of the virtual server from the service provision server 200 can be reduced as much as possible. Therefore, it is possible to suppress a period of time and the cost required for a software build.

Further, the build environment management server 100 determines performance of a virtual server such that the shorter a period of time until a due date of software, the higher the performance of the virtual server. Therefore, the shorter a period until a due date is, the shorter a period of time spent on a software build can be, and it is possible to ensure a period of time to be spent on development.

In a case in which a due date of software includes an unchangeable first-type due date and a changeable second-type due date, the build environment management server 100 makes a performance difference that is increased per unit period in a case in which the second-type due date is defined for the software be larger than a performance difference increased per unit period in a case in which the first-type due date is defined for the software. In a case in which a first-type due date is set, the cost is high as compared to a case in which a second-type due date is set. However, because a performance difference of a virtual server that is increased per unit period is large in a case in which a first-type due date is set, a period of time required for a software built is shortened. Therefore, it is possible to ensure a longer software development period. On the other hand, in a case in which a second-type due date is set, the cost can be low as compared to a case in which a first-type due date is set.

Further, the build environment management server 100 increases a performance difference that is increased per unit period, such that the larger the number or size of source files that configure software, the larger the performance difference. Generally, in a case in which the performances of virtual servers are the same, the larger the number or size of source files, the larger a load on a virtual server and the longer a period of time required for a software build. Further, as software development progresses, the number or size of source files increases. In a case in which the number or size of source files is large, the build environment management server 100 increases a performance difference that increases per unit period as compared to a case in which the number or size of source files is small. Therefore, it is possible to suppress an increase in period of time required for building software the number or size of source files of which increases as the development progresses.

Further, the build environment management server 100 sets a performance difference that is increased per unit period such that the higher a bug density of software, the larger the performance difference. Generally, in a case in which a bug density of software is high, the number of times a build is executed is large as compared to a case in which a bug density is low. Therefore, in a case in which a bug density of software is high, the build environment management server 100 increases a performance difference that is increased per unit period as compared to a case in which a bug density of software is low. Therefore, a build period of time is shortened, and it is possible to ensure a period of time for software bug improvement work.

Further, the version management server 201 stores the history of software build by a virtual server. The build environment management server 100 sets a performance difference that is increased per unit period such that the longer a period of time spent on a software build, the larger the performance difference. Therefore, in a case in which a period of time spent on a software build is long, the build environment management server 100 makes a performance difference that is increased per unit period large as compared to a case in which a period of time spent on a software build is short. Therefore, it is possible to suppress an increase in build period of time and ensure a period of time for software development.

Further, in a case in which software is developed by a plurality of developers, the build environment management server 100 sets a performance difference that is increased per unit period such that the larger the number of developers, the larger the performance difference. Generally, in a case in which the number of developers who develop software is large, the number of times a build is executed is large as compared to a case in which the number of developers is small. Therefore, in a case in which the number of developers who develop software is large, the build environment management server 100 makes a performance difference that is increased per unit period large as compared to a case in which the number of developers who develop software is small. Therefore, a build period of time is shortened, and it is possible to ensure a period of time for software development.

Further, the build environment management server 100 defines a plurality of performance levels corresponding to different degrees of performance of virtual server, determines one of the plurality of performance levels, and transmits, to the service provision server 200, a request for changing the performance of a virtual server to the performance defined by the determined performance level. Therefore, it is possible to change the performance of a virtual server formed in the service provision server 200.

Although embodiments of the present invention have been described and illustrated in detail, the disclosed embodiments are made for purpose of illustration and example only and not limitation. The scope of the present invention should be interpreted by terms of the appended claims.

What is claimed is:

1. A software build system comprising a hardware-processor,
the hardware processor:
acquiring a due date defined for software;
associating a virtual server provided by a service that supplies the virtual server with the software; and
determining performance of the virtual server based on information about the software.

2. The software build system according to claim 1, wherein
the hardware-processor sets performance of the virtual server such that the shorter a period until a due date of the software, the higher the performance of the virtual server.

3. The software build system according to claim 2, wherein
a due date of the software includes an unchangeable first-type due date and a changeable second-type due date, and
a performance difference increased per unit period by the hardware-processor is large in a case in which the first-type due date is defined for the software as compared to a case in which the second-type due date is defined for the software.

4. The software build system according to claim 2, wherein
the larger a count or size of source files that configure the software, the larger a performance difference increased per unit period by the hardware-processor.

5. The software build system according to claim 2, wherein
the higher a bug density of the software, the larger a performance difference increased per unit period by the hardware-processor.

6. The software build system according to claim 2, wherein
the hardware-processor stores a history of a build of the software executed by the virtual server, and
the longer a period of time spent on a build of the software, the larger a performance difference increased per unit period.

7. The software build system according to claim 2, wherein
in a case in which the software is developed by a plurality of developers, the larger a count of the plurality of developers, the larger a performance difference increased by the hardware-processor per unit period.

8. The software build system according to claim 1, wherein
the hardware-processor selects one of a plurality of performance levels having different performance degrees of the virtual server and requests the service to change a performance of the virtual server to a performance defined based on the selected performance level.

9. A software development assistance method including:
a due-date acquiring step of acquiring a due date defined for software;
an associating step of associating a virtual server provided by a service that supplies the virtual server with the software; and
a performance determining step of determining performance of the virtual server based on information about the software.

10. The software development assistance method according to claim 9, wherein
the performance determining step includes setting performance of the virtual server such that the shorter a period until a due date of the software, the higher the performance of the virtual server.

11. The software development assistance method according to claim 10, wherein
a due date of the software includes an unchangeable first-type due date and a changeable second-type due date, and
a performance difference increased per unit period in the performance determining step is large in a case in which the first-type due date is defined for the software as compared to a case in which the second-type due date is defined for the software.

12. The software development assistance method according to claim 10, wherein
the larger a count or size of source files that configure the software, the larger a performance difference increased per unit period in the performance determining step.

13. The software development assistance method according to claim 10, wherein
the higher a bug density of the software, the larger a performance difference increased per unit period in the performance determining step.

14. The software development assistance method according to claim 10, further including a history step of storing a history of a build of the software executed by the virtual server, wherein
the longer a period of time spent on a build of the software, the larger a performance difference increased per unit period in the performance determining step.

15. The software development assistance method according to claim 10, wherein
in a case in which the software is developed by a plurality of developers, the larger a count of the plurality of developers, the larger a performance difference increased per unit period in the performance determining step.

16. The software development assistance method according to claim 9, wherein
the performance determining step includes selecting one of a plurality of performance levels having different performance degrees of the virtual server and requesting the service to change a performance of the virtual server to a performance defined based on the selected performance level.

17. A non-transitory computer readable recording medium encoded with a software development assistance program that causes a computer to execute:
a due-date acquiring step of acquiring a due date defined for software;
an associating step of associating a virtual server provided by a service that supplies the virtual server with the software; and
a performance determining step of determining performance of the virtual server based on information about the software.
